(19) United States
(12) Patent Application Publication
(10) Pub. No.: US 2007/0032218 A1
(43) Pub. Date: Feb. 8, 2007

(54) Notice method for emergent dispatch using mobile communication device

(76) Inventor: Yong-Hak Choi, Seoul (KR)

Correspondence Address: PARK LAW FIRM, 3255 WILSHIRE BLVD, SUITE 1110, LOS ANGELES, CA, 90010, US

(21) Appl. No.: 10/551,491

(22) PCT Filed: Oct. 17, 2003
(86) PCT No.: PCT/KR03/02167

§ 371 Date: Sep. 29, 2005

(30) Foreign Application Priority Data
Apr. 4, 2003 (KR) 10-2003-0021506

(51) Int. Cl. H04M 11/04

(52) U.S. Cl. 455/404.1

(57) ABSTRACT

The present invention relates to a notice method for emergent dispatch using a mobile communication device, and in particular to a notice method for emergent dispatch in which a mobilization service company is capable of accurately mobilizing to a customer's position when a customer who stays at a certain place inputs a staying place and staying time, and transmits an emergency signal within the staying time.

### TECHNICAL FIELD

The present invention relates to a notice method for an emergency dispatch using a mobile communication device capable of fast and accurately detecting a customer's position when a customer is in an emergency, in detail, to a notice method for an emergency dispatch using a mobile communication device which is implemented in such a manner that when a customer visits a certain place, a visiting place and staying time are inputted and set in advance and the customer transmits an emergency signal within the set time, a dispatch staff is dispatched to the customer's position.

In addition, the present invention relates to a method for protecting a member using an emergency dispatch notice according to the present invention while the member stays at home.

### BACKGROUND ART

As a conventional method for detecting a member's position using a mobile communication device which is generally used for an emergency dispatch service, there are a GPS (Global Positioning System) method, and a gpsOne method which is currently used by a mobile communication service company. However, in case of the GPS method, it is impossible to detect the member's position, on the occasion a member is in the indoors and in case of the gpsOne method also, on the occasion a member is in the indoors, because a position error exceeds 1 km, in the event a certain emergency occurs to the member who is in the indoors, it is impossible to detect the member's position accurately. Therefore, there are problems in properly protecting the member from an emergency.

In addition, a usual burglary prevention system has the problem that because it is designed to protect valuables stored in home, in case they would like to protect a human being, not the valuables, it is needed to install an expensive controller additionally and therefore, the cost is increased.

### DISCLOSURE OF INVENTION

It is an object of the present invention to overcome the problems encountered in the usual art.

It is another object of the present invention to provide a notice method for an emergency dispatch, which is capable of detecting a member's position accurately even when the customer in emergency is in the indoors or the outdoor, for thus effectively protecting the member who is in emergency.

It is further another object of the present invention to provide a notice method for an emergency dispatch which is capable of quickly protecting a member from an external intruder when the member stays at home.

To achieve the above objects, there is provided a notice method for an emergency dispatch using a mobile communication device which includes a the central control server system constructing step for controlling a transmission and receiving operation of an information, a member information database constructing step for storing a member information such as a name, age, cellular phone number, etc. of a member in cooperation with the central control server system, a position information database constructing step for storing a member's staying place and time in cooperation with the central control server system, a protection state start step which manages a member's staying place and staying time that is started by a control of the central control server system, an emergency signal receiving step in which the central control server system receives an emergency signal from the member's mobile communication device, and a position information transmission step in which the central control server system which receives the emergency signal transmits a member's basic information and position information to the mobile communication device of the dispatch staff.

In the emergency signal receiving step, the member's mobile communication device transmits an emergency signal using a shortcut key of the member's mobile communication device or a previously set protocol.

In the emergency signal receiving step, the member's mobile communication device receives a signal from a local area transmission device connected with the member's mobile communication device based on a wireless or wired method, and the member's mobile communication device transmits an emergency signal to the central control server system.

In the emergency signal receiving step, the member's mobile communication devices receives a signal from an apparatus connected with the member's mobile communication device based on a wireless or wired method and designed to measure a member's body state, and the member's mobile communication device transmits an emergency signal to the central control server system.

In the emergency signal receiving step, the member's mobile communication devices receives an intrusion detection signal from an intrusion detection sensor installed at a member's home, and the member's mobile communication device transmits an emergency signal to the central control server system.

### BRIEF DESCRIPTION OF DRAWINGS

The present invention will become better understood with reference to the accompanying drawings which are given only by way of illustration and thus are not limitative of the present invention, wherein;

FIG. 1 is a view illustrating the construction of an emergency dispatch notice method according to the present invention;

FIG. 2 is a view illustrating the construction of a system for implementing an emergency dispatch notice method according to the present invention; and

FIG. 3 is a view illustrating the construction of a system for implementing an emergency dispatch notice method for protecting a customer according to the present invention.

### BEST MODE FOR CARRYING OUT THE INVENTION

The preferred embodiments of the present invention will be described with reference to the accompanying drawings.

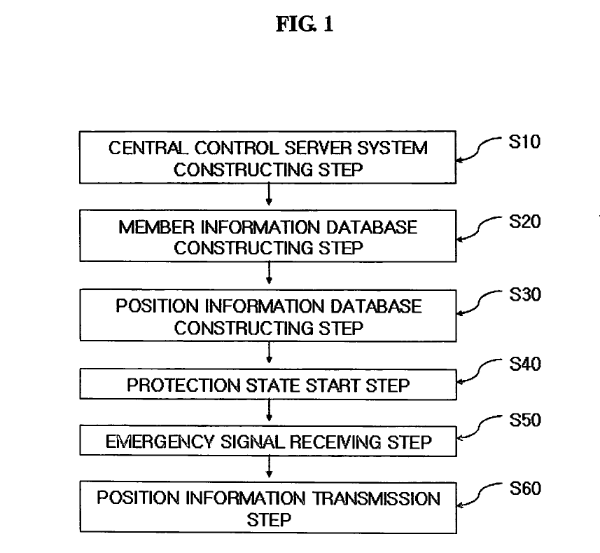

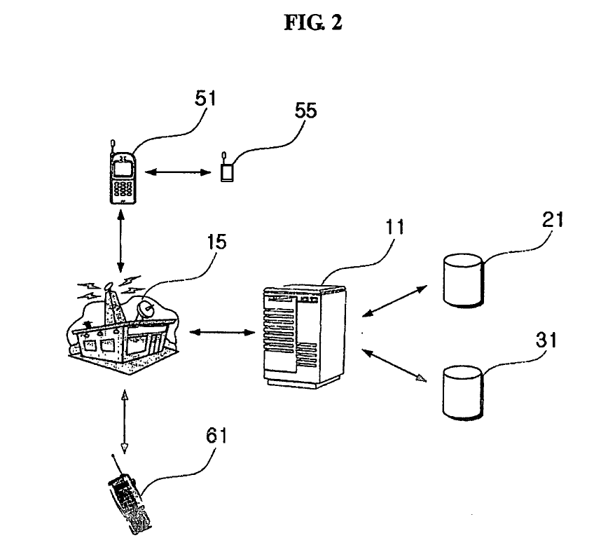

FIG. 1 is a view illustrating the construction of an emergency dispatch notice method according to the present invention, and FIG. 2 is a view illustrating the construction of a system for implementing an emergency dispatch notice method according to the present invention.

With reference to FIG. 1, the emergency dispatch notice method according to the present invention will be described.

The emergency dispatch notice method according to the present invention includes a central control server system constructing step (S10), a member information database construction step (S20), a position information database constructing step (S30), a protection state start step (S40), an emergency signal receiving step (S50), and a position information transmission step (S60).

In the central control server system constructing step (S10), a central control server system (11) which is a computer system for comprehensively controlling each step of an emergency dispatch service according to the present invention is constructed. The step (S10) may include a step for constructing a web site in cooperation with the central control server system (11).

The member information database constructing step (S20) is formed of processes such as a member gathering process and a member information collecting process and a member information storing process, and is step of constructing member information database by storing personal information such as a member's name, age, address, cellular phone number, etc. of a member who subscribes an emergency dispatch service of the present invention in an additional storing apparatus in cooperation with the central control server system (11). In the member information database constructing step (S20), a member and member information can be gathered and collected on the online through the web site, or can be gathered and collected through a telephone contact or a postal method, The collected member's information is stored in the storing apparatus of the member information database (21), and the transmission and receiving operation of the stored information is controlled in cooperation with the central control server system (11).

In the position information database constructing step (S30), there are provided a step for inputting an information concerning a member's staying position and time and visiting frequency, and a step for storing the inputted information into the position information database (31). In the case that a certain member stays at a certain place, the member's basic information, staying place and staying time and visiting frequency are stored, and the inputted position information is stored in an additional storing apparatus in cooperation with the central control server system (11) for thereby constructing the position information database (31). The position information that the member inputs is stored in the storing apparatus of the position information database (31), and the transmission and receiving operation of the information is controlled in cooperation with the central control server system (11).

The member may input the staying place and time on the web site of the internet which cooperates with the central control server system (11) and may input using a member's mobile communication device (51).

The position information database (31) is separated into one time visit and multiple time visits. The one time visit is used, in case a certain member stays in a certain place one time. The staying place and time are inputted and when the staying time is passed, the emergency signal service is finished. Therefore, the member inputting the position information must input whether his visit is one time visit or not. The multiple time visits is used, in case a certain member repeatedly visit on a certain date or day at a certain time. If the member inputs the staying place and time once, the emergency signal service is continuously maintained unless the member finish the service. Therefore, the position information database (31) of the member is constructed divided one time visit and multiple time visits.

In the protection state start step (S40), storing apparatus of the position information database (31) which connects with the central control server system (11) receives an position information of the member whose staying time starts and the central control server system (11) manages the information separately. While staying time of the member in staying place is being passed, the central control server system (11) manages it separately and if necessary, the information may be displayed on an additional display device (not shown in fig.) such as a monitor. The managed data are classified into a member's basic information, staying place and staying time data.

In the emergency signal receiving step (S50), there are provided a step in which a member directly operates the member's mobile communication device (51) or operates the same using an additional transmission apparatus, so that the member's mobile communication device transmits an emergency signal, and a step that the central control server system (11) receives an emergency signal. In the case that a member is in an emergency, an emergency signal is transmitted using the member's mobile communication device (51), and the signal is received by the central control server system (11) through the mobile communication system (15) of the mobile communication service provider.

At the time, the member may transmit an emergency signal to the emergency signal number of the central control server system (1) using the member's mobile communication device (51). A shortcut key may be set in the member's mobile communication device (51) for thereby more quickly transmitting the emergency signal. The central control server system (11) may set a certain emergency signal number with the member. Then, when the set number rings, it is recognized as emergency signal. Besides, a certain protocol may be set for the emergency signal.

In addition, in a method that the member transmits an emergency signal, a local area transmission device (55) capable of transmitting the emergency signal based on a wired method pr wireless method may be provided in the member's mobile communication device (51). For example, when a button provided in a small item such as a wireless earphone or accessory which may be carried by a user is pressed, a certain signal is outputted and the member's mobile communication device (51) has a function for receiving the above signal. When the member presses the button provided in the local area transmission device (55) which generates the certain signal, the member's mobile communication device (51) receives the signal, and the member's mobile communication device (51) automatically transmits the emergency signal to the central control server system (11).

Here, similar to the local area transmission device (55), the method that emergency signal transmit using the device which measure a heart pulse or temperature of a human body and if abnormality is detected, output emergency signal can be used. Namely, by annexing a transmitter capable of generating a signal based on a wireless method or wired method to a device capable of measuring a heart pulse, temperature, blood pressure, sweat, etc. of a human body, if an abnormality of the heart pulse, etc is detected, a certain signal can be outputted, and the signal is received by the member's mobile communication device. Then, the member's mobile communication device transmits an emergency signal to the central control server system. Further, the device capable of measuring a heart pulse, temperature, blood pressure, and sweat of a human body may be fabricated in a small size in a chip or module type and installed in the mobile communication device. Using the above method, it is possible to easily transmit an emergency signal when the member is in the emergency state.

In the position information transmission step (S60), there are provided a step that the central control server system (11) selects a dispatch staff, and a step for transmitting a position information of a member who transmitted the emergency signal. When the emergency signal is received from the member, the central control server system (11) selects a dispatch staff who is placed in the nearest position from the position of the member and transmits the basic information and position information concerning the member to the mobile communication device (61) of the dispatch staff. The position information may be transmitted to the mobile communication device (61) of the dispatch staff through a SMS (Short Message Service) or an upload method through the wireless internet.

When the emergency signal and the position information of the member are received, the dispatch staff dispatches and rescues the member who is in the emergency state. The dispatch staff has the mobile communication device (61) capable of receiving the emergency signal, the member's basic information and the position information from the central control server system (11). It is desirable that the service area is divided into small service area and a certain number of the dispatch staff is allocated to each service area.

Referring to FIG. 2, the system for implementing the emergency dispatch notice method according to the present invention will be described.

The above system includes a central control server system (11), a mobile communication system (15) of a mobile communication service provider, a member information database (21), a position information database (31), a mobile communication device (51) of a member, and a mobile communication device (61) of a dispatch staff.

The central control server system (11) is connected with the wired or wireless internet and performs a function for controlling the information transmission and receiving operations of the member information database (21) and the position information database (31) and a function for receiving a member's emergency signal through the mobile communication system (15) and transmitting to the mobile communication device (61) of the dispatch staff.

The wired internet transmits and receives an information based on the HTTP (HyperText Transfer Protocol) used for transferring the hypertext documents on the internet.

The wireless internet transmits and receives an information based on the WAP (Wireless Application Protocol) which is protocol to standardize the method that connects a mobile communication device such as a cellular phone, personal information terminal, etc. with an internet through an electronic mail, voice and video transfer, etc.

The member information database (21) and the position information database (31) is operated in cooperation with the central control server system (11) and organized including an information storing apparatus which is capable of storing and reading information.

A cellular phone or personal information terminal can be used as the mobile communication device (51) of the member. The mobile communication device (51) may have a function for receiving a signal from the local area transmission device (55). The local area transmission device (55) is a signal transmission device capable of transmitting a signal to the mobile communication device based on a wireless method or wired method.

The mobile communication device (61) of the dispatch staff is a communication device capable of receiving a basic information and position information of a member from the central control server system (11) whose emergency signal is transmitted and include a cellular phone, a personal information terminal, etc.

Next, the emergency dispatch notice method for protecting a member while the member stays at home according to another embodiment of the present invention will be described.

Present embodiment is characterized that an intrusion detection sensor (58) automatically performs the process that the local area transmission device transmits a signal to the member's mobile communication device (51) in an emergency signal receiving step (S50) of FIG. 1.

In the position information database constructing step (S30) of FIG. 1, the staying place of the member is his home, and the staying time is set as a period that the member stays at home.

In the emergency signal receiving step (S50) of FIG. 1, when the intrusion detection sensor (58) installed the member's home operates and detects an intrusion, an intrusion detection signal is transmitted to the member's mobile communication device (51), and the member's mobile communication device (51) transmits an emergency signal to the central control server system (11).

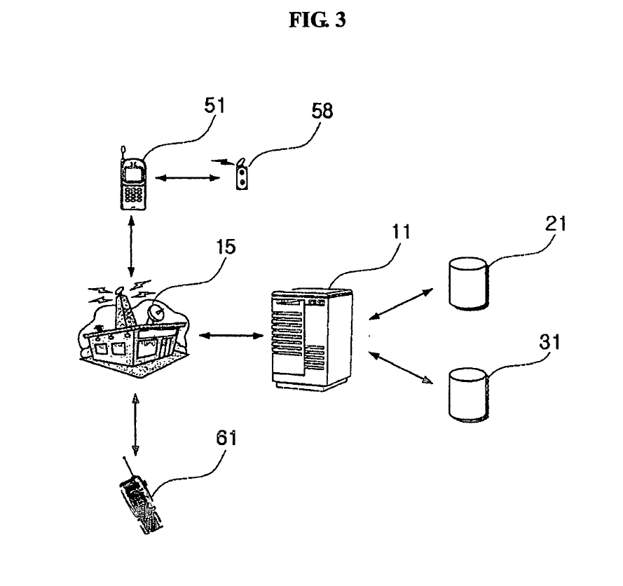

FIG. 3 is a view illustrating a system of an emergency dispatch notice method for protecting the member while the member is staying at home according to the present invention. As shown therein, an intrusion detection sensor (58) installed in the member's home is further supplied to the system of FIG. 2.

The intrusion detection sensor (58) is installed at an entrance door, a window, etc. and detects a motion of an extruder. When a motion is detected, the intrusion detection signal is transmitted to the member's mobile communication device (51).

All sort sensor such as an infrared ray detection sensor, magnetic detection sensor, etc. which is capable of detecting a motion of a person or an opening and closing operation of an entrance door can be used as the intrusion detection sensor (58). The infrared ray detection sensor is a sensor capable of detecting an intrusion using infrared ray, and the magnetic detection sensor is a sensor for detecting an intrusion using a magnet.

The member's mobile communication device (51) has a function capable of detecting a signal from the intrusion detection sensor (58). The signal transmission or receiving operation between the intrusion detection sensor (58) and the member's mobile communication device (51) can be directly achieved or achieved through the certain repeater (not shown in FIG. 3) installed in home. In the case that there is a difference between the signal transmitted from the transmission device (55) of FIG. 2 and the signal transmitted from the intrusion detection sensor (58), the repeater converts the signal from the intrusion detection sensor (58) into the signal same as the signal from the transmission device (55) and transmits the converted signal. Therefore, in the case that the repeater is used, even when the signal from the local area transmission device (55) of FIG. 2 is different from the signal from the intrusion detection sensor (58) of FIG. 3, it is possible to implement the above two embodiments of the present invention by simply adding a function capable of receiving one kind of signal to the member's mobile communication device (51).

Because the signal transmission and receiving range between the intrusion detection sensor (58) and the member's mobile communication device (51) is short, above the another embodiment is possible in the case that the member stays at home and in the case that the member is out of the home it is impossible to receive a signal from the intrusion detection sensor (58).

The present invention is not limited by the desirable embodiment described above, and it is of course possible that not deviating from the point of present invention claimed in claims, anyone, a person who has common knowledge in this technical field, can practice the present invention with a various changed form. Therefore, the metamorphosis like that comes to belong to the right range of the present invention.

### INDUSTRIAL APPLICABILITY

As described above, even when it is impossible to detect the member's position using a conventional positioning system because the member stays in the indoor, the present invention is capable of accurately detecting the member's position for thereby effectively dealing with the member's emergency.

While the member stays at home, the present invention may be used for protecting the member, so that it is possible to effectively protect the member's body.

What is claimed is:

1. A notice method for an emergency dispatch using a mobile communication device, comprising the steps of:
a central control server system constructing step for controlling a transmission and receiving operation of an information;
a member information database constructing step for storing a member information such as a name, age, cellular phone number, etc. of a member in cooperation with the central control server system;
a position information database constructing step for storing a member's staying place and staying time in cooperation with the central control server system;
a protection state start step for managing a member's staying place and staying time that is started by control of the central control server system;
an emergency signal receiving step in which the central control server system receives an emergency signal from the member's mobile communication device; and
a position information transmission step in which the central control server system which receives the emergency signal transmits a member's basic information and position information to the mobile communication device of the dispatch staff.

2. The method of claim 1, wherein in said emergency signal receiving step, the member's mobile communication device transmits an emergency signal using a shortcut key of the member's mobile communication device or a previously set protocol.

3. The method of claim 1, wherein in said emergency signal receiving step, the member's mobile communication device receives a signal from a local area transmission device connected with the member's mobile communication device based on a wireless or wired method, and the member's mobile communication device transmits an emergency signal to the central control server system.

4. The method of claim 1, wherein in said emergency signal receiving step, the member's mobile communication devices receives a signal from an apparatus connected with the member's mobile communication device based on a wireless or wired method and designed to measure a member's body state, and the member's mobile communication device transmits an emergency signal to the central control server system.

5. The method of claim 1, wherein in said emergency signal receiving step, said member's mobile communication devices receives an intrusion detection signal from an intrusion detection sensor installed at a member's home, and the member's mobile communication device transmits an emergency signal to the central control server system.
